(19) United States
(12) Patent Application Publication
(10) Pub. No.: US 2020/0254841 A1
(43) Pub. Date: Aug. 13, 2020

(54) CONTROL ARM END

(71) Applicant: SAF-HOLLAND GmbH, Bessenbach (DE)

(72) Inventors: Stefan Fäth, Aschaffenburg (DE); Thomas Josef Naber, Ahaus (DE)

(21) Appl. No.: 15/769,006

(22) PCT Filed: Oct. 18, 2016
(86) PCT No.: PCT/EP2016/074964

§ 371 Date: Apr. 17, 2018

(30) Foreign Application Priority Data
Oct. 19, 2015 (DE) 10 2015 117 757.9

(51) Int. Cl. B60G 7/00; B60G 17/056; F16K 17/196

(52) U.S. Cl. CPC B60G 7/001; B60G 17/056; F16K 17/196; F16F 9/049; B60G 2202/152; B60G 2206/012; B60G 2300/02; B60G 2206/8107

(57) ABSTRACT

An arm end for a trailing arm, in particular for commercial vehicles, comprising a main body which configures a working volume for an air spring system, the main body having an access region which is designed to provide an access into the working volume, characterized in that a large part of the working volume is configured substantially below the access region.

### BACKGROUND OF THE INVENTION

The present invention relates to an arm end for a trailing arm, in particular for commercial vehicles, to a trailing arm, and to a valve unit.

Trailing arms are used in wheel suspension systems of motor vehicles and are predominantly oriented in the longitudinal direction of the vehicle. They serve to support brake forces and brake reaction torques. In addition, they are the decisive parts of a suspension system as a result of their movable mounting. Air spring systems, above all, are used for providing the suspension effect in the commercial vehicle sector. Here, spring bellows, in particular made from rubber, are connected to a working volume which is closed in an airtight manner, and thus provide the suspension effect. The disadvantage here is that the working volume takes up a large amount of installation space which is not available in the region of the chassis.

It is therefore an object of the present invention to specify an arm end for a trailing arm, a trailing arm and a valve unit which make a compact and inexpensive air spring system possible, in particular for commercial vehicle applications.

### SUMMARY OF THE INVENTION

According to the invention, an arm end for a trailing arm, in particular for commercial vehicles, comprises a main body which configures a working volume for an air spring system, the main body having an access region which is designed to provide an access into the working volume, characterized in that a large part of the working volume is configured substantially immediately below the access region. An air spring system is a suspension system which utilizes the compressibility of gases, more precisely of air. Advantages of the air spring system are the smooth and comfortable ride and the variable vehicle height. The air spring system serves both to cushion two vehicle parts which can be moved relative to one another, and to change the ride level position of the vehicle. The ground clearance can therefore be varied. The suspension takes place by means of air or spring bellows, expediently made from a plastic material, in particular a rubber material, in which bellows compressed air forms the counterforce to the driving dynamics forces at the respective wheel or the axle at a variable pressure during compression and rebound. The arm end is that component which serves to arrange/fasten the air spring system and, in particular, the (air) spring bellows, namely by virtue of the fact, in particular, that it has the access region. To this end, the arm end expediently has an upper section which has or comprises the abovementioned access region. In one embodiment, the upper section is a substantially smooth/planar/flat surface which has the access region. According to one embodiment, the access region is configured as a hole, opening or generally as an aperture which provides an access into the interior of the arm end, the access being configured in such a way that air can flow into and out of the working volume. In one embodiment, the upper section comprises a cylindrical section which can configure, in particular, a rolling piston for an air bellows. The cylindrical section expediently serves to arrange/fasten the spring bellows and has the access region. In other words, the access region is arranged within the cylindrical section, for example substantially centrally in one embodiment. The term “arm end” relates to the fact that the arm end, or else “tail end”, is that part of the trailing arm which is arranged at the very back as viewed in the driving direction. A front or opposite end of the trailing arm expediently has a pivot point, via which the movable arrangement of the trailing arm on a vehicle frame takes place. In addition, the trailing arm also has an arranging section for an axle tube. In the present case, the term “trailing arm” is also used for a trailing arm which possibly does not yet have an arm end and is therefore perhaps strictly speaking not a “complete” trailing arm. It is known in part from the prior art to use the volumes of adjoining vehicle parts in some way as equalization volumes or the like for the air spring system. In the present case, the arm end expediently comprises the main body which directly configures the working volume itself, the “working volume” also including any additional volumes, etc. here. In this way, a compact structural unit is advantageously achieved which saves any connecting elements such as hoses, couplings, seals, etc., as a result of which a simple and inexpensive system/product can be realized. In one embodiment, the working volume is a closed volume which is configured substantially directly below the access region. This means that, as has been mentioned at the outset, a large part of the working volume is configured below the access region or below the lower section. Here, the expression “large part” means that more than 50%, in particular more than 60, 70 or 80% of the working volume is directly arranged immediately below the access region. In one embodiment, the working volume comprises, for example, approximately from 10 to 100 l, possibly from 20 to 80 l, or also preferably between 30 and 60 l. A ratio between a volume of an air spring bellows to the working volume expediently lies in a range of from approximately 0.91 to 0.34, preferably in a range of from approximately 0.67 to 0.5. In one embodiment, the working volume is delimited toward the top by way of the upper section, which means that the working volume does not have any installation space above the preferably planar upper section.

In one embodiment, the main body is a closed hollow body, the hollow body expediently having the access region. The closed hollow body can be a welded construction from metal, in particular steel or aluminum. In another embodiment, the hollow body is a component which is hydroformed. As an alternative, the at least partial use of fiber composite materials, such as glass fiber reinforced or carbon fiber reinforced materials, can also be provided, which additionally increases the possible variety of shapes. As has already been mentioned, the access region is an opening which can have a very wide variety of geometries and dimensions and as a rule complies with the type and size of the air spring system which is used and/or the spring bellows which is used. In particular, the access region can also have, for example, a multiplicity of openings, for example two, three, four, five, six and more. “Closed” is to be understood such that the main body does not have any further connectors for any additional volumes or equalization volumes, but rather can perform said functions itself on account of its dimensioning and design.

In one embodiment, the main body has a lower section opposite the access region or opposite the upper section, the lower section being spaced apart from the access region or from the upper section by more than 5 cm, preferably by more than 8 cm and, in particular, preferably by more than 10 cm. In one embodiment, the lower section is formed by way of a substantially planar lower face which extends substantially parallel to the roadway plane. It goes without saying that the lower face can also be inclined forward, rearward or toward the sides. It is decisive that the lower face provides a sufficiently great working volume as a result of its spacing from the access region or from the upper section. In one embodiment, the upper section and the lower section are oriented approximately parallel to one another and are at a spacing of approximately from 10 to 50 cm, preferably of approximately from 13 to 30 cm. Toward the rear, that is to say counter to the driving direction, the main body is delimited by way of a rear section which, in one embodiment, is oriented substantially perpendicularly with respect to the upper and lower section. Toward the front, the main body is delimited by way of a front section. In one embodiment, the front section is configured or oriented at least in regions parallel to the rear section. According to one embodiment, a lower region of the front section can be oblique or inclined. In one embodiment, the main body has an approximately cuboid design. In one embodiment, a length of the main body of the arm end is approximately from 30 to 60 cm, preferably approximately from 40 to 50 cm. A projecting length of the arm end which is measured from an axle tube center to the rear section (substantially parallel to a roadway plane or along a longitudinal direction of the trailing arm) is expediently smaller than 90 cm. In one embodiment, the projecting length is, for example, between 30 and 90 cm, preferably between 40 and 60 cm. In one embodiment, a width of the main body is approximately from 20 to 50 cm, preferably approximately from 25 to 40 cm. The height or the spacing between the upper and the lower section has already been mentioned. In one embodiment, a wall thickness is approximately from 3 to 7 mm, preferably approximately from 4 to 5 mm.

Although it is a hollow body, the main body can also have a reinforcement in the form of ribs, struts or generally reinforcing elements in the interior in one embodiment, which reinforcing elements are designed to increase the strength and/or rigidity of the main body. Therefore, both the gas forces act in the interior on said main body, and the forces which are introduced by way of the spring bellows also act on said main body from the outside, with the result that a stable construction is imperative.

In one embodiment, the lower section comprises a support face which is designed for arranging and fastening the arm end on/to a trailing arm. In one embodiment, the support face is arranged offset in the direction of the access region, with the result that the lower section does not have a straight face. In one embodiment, the support face is offset by a spacing in the direction of the access region or in the direction of the upper section by approximately from 5 to 20 cm, preferably by approximately from 8 to 15 cm. In one embodiment, a width of the support face is approximately from 5 to 20 cm, preferably approximately from 8 to 15 cm. However, the lower section can also itself fulfill the function of the support face. The support face is fundamentally designed in such a way that it is configured or designed for arranging or for mounting on a trailing arm. The connection to the trailing arm can take place via a positively locking and/or non-positive connection or else via an integrally joined connection, such as welding or adhesive bonding. Corresponding rivets, bolts and the like can be used for the positively locking and/or non-positive connection.

As has already been mentioned, the main body also has a front section which can likewise provide the function of a support or arranging face, in other words is therefore designed for arranging the arm end on a trailing arm. In one embodiment, this is a substantially horizontal outer wall which is designed in such a way that it can be arranged on and fastened to, for example welded to, a trailing arm. Here, the outer wall can be smooth or else structured, in order possibly to also make a positively locking connection to the trailing arm possible. In one embodiment, the arm end is arranged on and fastened to a trailing arm via the lower section or the support face and the front section. In another embodiment, the arm end is fastened to the trailing arm only by means of the front section, for example via a positively locking and/or non-positive and/or integrally joined connection.

In one embodiment, the arm end comprises a valve unit which comprises a clamping plate, the clamping plate having a multiplicity of valve openings, in particular four valve openings. In one embodiment, the valve unit is provided in the access region or in the transition region between the volume of the spring bellows and the working volume, which valve unit opens and closes in accordance with the pressure conditions in the two volumes. In accordance with one embodiment, the clamping plate is arranged in or on the upper section of the main body or in or on the cylindrical section. In one embodiment with four valve openings, in each case two valve openings have a (maximum) cross section of approximately from 400 to 1500 mm², preferably of approximately from 500 to 1200 mm², particularly preferably of approximately from 600 to 1000 mm². In principle, the cross section is dependent on the prevailing pressure difference and the frequency (which occurs). In this context, the unit mm²/bar is customary, typical values lying in a range of approximately from 450 to 650 mm²/bar, preferably at approximately from 480 to 620 mm²/bar (10 Hz approximately 1.2 bar, 5 Hz approximately 0.3 bar, 15 Hz approximately 0.4 bar). Accordingly, preferred cross-sectional values lie in a range of approximately from 0 to 800 mm² or, if there is a bypass, in a region of approximately from 20 to 800 mm². A damping action can be generated by way of the air spring system as a result of the friction in the valve unit. This can make it possible to dispense with a (shock) damper. In one embodiment, the clamping plate is round, in particular circular, and has a diameter of approximately from 70 to 120 mm, preferably of approximately from 80 to 110 mm, and very particularly preferably of approximately from 90 to 100 mm, for example 94 mm. In one embodiment, the clamping plate has a wall thickness of approximately from 2 to 7 mm, preferably of approximately from 3 to 6 mm and very particularly preferably of approximately from 4 to 5 mm, for example 4.6 mm. In one embodiment, the clamping plate is manufactured from metal or from a plastic. In one embodiment, one or more guide pins are arranged in the clamping plate in such a way that the movement of the valve flaps which are described in the following text is guided by way of the guide pins. In particular, the guide pins prevent a rotation of the valve flaps with respect to one another. The guide pins can be configured, for example, as cylindrical pins which have a length of approximately 15 mm and a diameter of approximately 2 mm.

In one embodiment, the valve unit comprises an upper valve flap and a lower valve flap, the valve flaps being arranged in such a way that in each case different valve openings can be opened and closed. The upper valve flap is expediently arranged above the clamping plate, and the lower valve flap is expediently arranged below the clamping plate. The valve flaps expediently have corresponding sections/regions which are designed to cover the valve openings of the valve unit or the clamping plate. In accordance with one embodiment, the valve flaps which lie opposite one another are arranged offset, for example offset by 90°, in such a way that they can in each case cover and open different valve openings.

The valve unit expediently comprises a guide element which is designed in such a way that the valve flaps can move along the guide element. In accordance with one embodiment, the guide element is a pin, bolt, web or else a screw which does not have a thread at least in regions. A cross section of the guide element is therefore preferably round, in particular circular. An oval or polygonal cross section can likewise be expedient, since the abovementioned guide pins can possibly be dispensed with as a result. In accordance with one embodiment, a diameter of a round cross section lies in a range of approximately from 4 to 8 mm, preferably in a range of approximately from 5 to 7 mm, for example 6 mm. The guide element is arranged in a corresponding opening/cutout of the clamping plate, expediently centrally.

In a basic position, the valve flaps bear against the clamping plate in such a way that the valve openings are closed.

To this end, the valve unit expediently comprises a prestressing or spring element which prestresses the valve flaps in the direction of the clamping plate or loads them with a (spring) force. The spring element is expediently arranged between one of the valve flaps and a supporting element in such a way that a compression of the spring element takes place in the case of a movement of the lower valve flap downward and in the case of a movement of the upper valve flap upward. In accordance with one embodiment, for example, the spring element is arranged between the lower valve flap and the supporting element, the further element being a washer which is supported on a screw which is configured as a guide element (for example, via a nut which is arranged there). The arrangement is advantageously configured in such a way that the valve flaps are braced against one another if only one spring element is used. If the spring bellows is loaded, the pressure in the volume of the spring bellows is increased by way of the compression of said spring bellows. The positive pressure or the pressure difference between the pressure in the working volume and the pressure in the spring bellows brings about, counter to the force of the spring element, a movement of the lower valve flap downward counter to the spring force. The expansion of the spring bellows (during rebound) leads to a differential pressure between the volume of the spring bellows and the working volume in such a way that a higher pressure prevails in the working volume than in the volume of the spring bellows. Said pressure difference brings about, counter to the force of the spring element, a movement of the upper valve flap upward. There is therefore an upper position, in which the upper valve flap is in an upper position, and a lower position, in which the lower valve flap is in a lower position. Here, the movement of the valve flaps does not take place solely merely by way of a pressure ratio prevailing, but rather also directly by way of the gas pressure which acts on the surfaces of the valve flaps which are not covered by way of the clamping plate or the respective other valve flap. In principle, the prestressing or spring element can be an elastomeric element or a coil spring, in particular a cylindrical compression coil spring, for example in accordance with DIN 2098 with the dimensions 1×8×13. The guide element is expediently positioned within the spring element.

In one embodiment, the valve flaps are configured with two blades, with the result that they can in each case close two openings of the valve unit. The shape of the valve flaps is expediently adapted to the shape of the valve openings. The valve openings can be of round, polygonal, slot-like, triangular, etc. configuration, there being no limits placed on their shape. The abovementioned cross sections of the valve openings can be configured with an identical or else different size, as a result of which the damping characteristics can be influenced. In one embodiment, a diameter of the valve flaps is approximately from 3 to 10 cm, preferably approximately from 4 to 8 cm. The valve flaps expediently have corresponding guide openings, for example in the form of holes or bores for receiving/arranging the abovementioned guide pins.

In accordance with an alternative embodiment, the clamping plate can also be dispensed with. In this case, the access region has the valve openings and provides the properties of the clamping plate.

The invention also comprises a trailing arm, in particular for commercial vehicles, which trailing arm comprises an arm end according to the invention. A rear part of the trailing arm is therefore advantageously configured as the arm end according to the invention.

In one embodiment, the trailing arm and the arm and can be configured in one piece. In one embodiment, a single-piece structure is therefore meant literally, that is to say no positively locking and/or non-positive connection or else integrally joined connection between a trailing arm (front part) and an arm end, but rather the configuration of the trailing arm as one part, the rear part being configured as the arm end according to the invention. In accordance with one embodiment, the feature relating to the “one-piece design” is also to be interpreted such that at least one region, comprising the arm end and a center part of the trailing arm, is configured in one piece or is made from one piece.

Furthermore, the invention also comprises a valve unit according to the invention. It goes without saying that the advantages and features which are mentioned in conjunction with the arm end according to the invention also apply to the trailing arm according to the invention and the valve unit according to the invention, and also vice versa and among one another.

Further advantages and features result with reference to the appended figures from the following description of preferred exemplary embodiments of the arm end according to the invention, the trailing arm according to the invention and the valve unit according to the invention. Here, individual features of the individual embodiments can be combined with one another within the context of the invention.

### BRIEF DESCRIPTION OF THE DRAWINGS

In the drawing:

FIG. 1 shows one embodiment of an arm end, arranged on a trailing arm;

FIG. 2 shows one embodiment of an arm end, arranged on a trailing arm;

FIG. 3 shows one embodiment of an arm end, arranged on a trailing arm;

FIG. 4 shows one embodiment of a valve unit;

FIG. 5a shows one embodiment of a valve unit in a plan view;

FIG. 5b shows the section A-A which is labeled in FIG. 5a;

FIG. 6a shows one embodiment of a valve unit in a side view; and

FIG. 6b shows that embodiment of the valve unit which is known from FIG. 6a, in the case of which the valve flaps are in a different position.

### DETAILED DESCRIPTION OF THE PREFERRED EMBODIMENTS

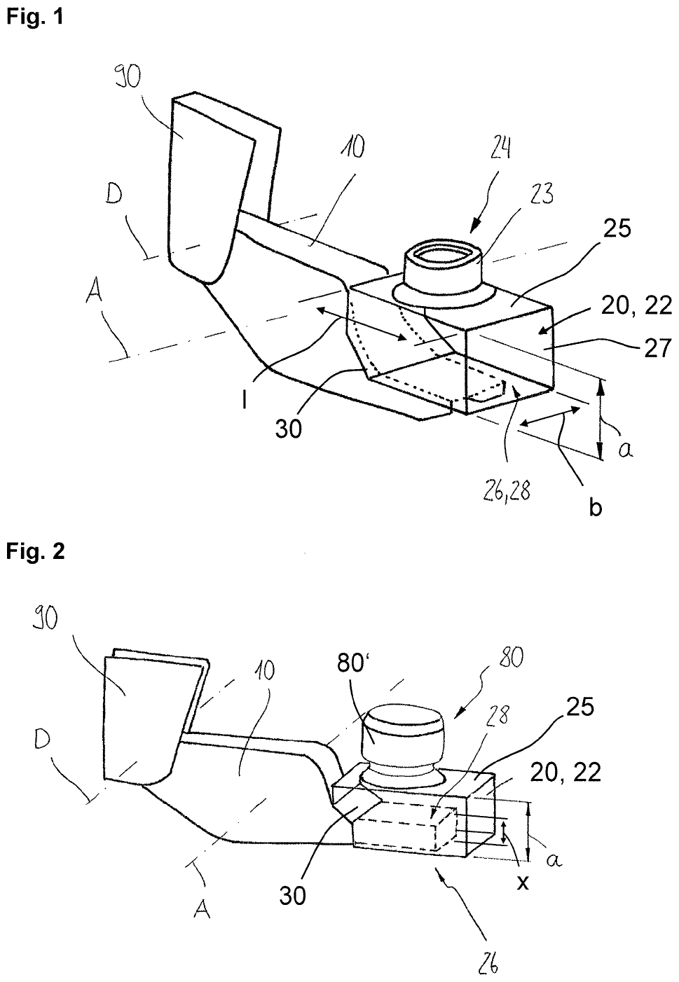

FIG. 1 shows an arm end 20 with a main body 22 which is arranged on a trailing arm 10 via a lower section 26. To this end, the lower section 26 is configured partially as a support face 28 and is arranged substantially so as to lie opposite an upper section 25. The upper section 25 comprises a cylindrical section 23 which has an access region 24. A spacing a extends between the upper section 25 and the lower section 26. The trailing arm 10 is arranged via a pivot point D in a vehicle frame/chassis 90. An axle tube is not illustrated which extends along the axial direction A and would be correspondingly arranged in the trailing arm 10. A length l is measured between a front section 30, via which an at least partial arrangement/fastening on the trailing arm 10 can likewise take place, and a rear section 27. The main body 22 has a width b and is of substantially cuboid shape, a working volume which is configured by way of the main body 22 being arranged substantially below the access region 24.

FIG. 2 shows a similar configuration to FIG. 1; here, however, a bearing face 28 which likewise serves for arranging on a trailing arm 10 is arranged offset by an offset x with respect to a lower section 26. A spacing a extends between an upper section 25 and a lower section 26. An air spring system 80 which comprises a spring bellows 80′ is arranged on the upper section 25 or an access region (concealed by way of the arrangement of the spring bellows 80′). A main body 22 comprises a front section 30, via which an arrangement on the trailing arm 10 likewise takes place at least in regions.

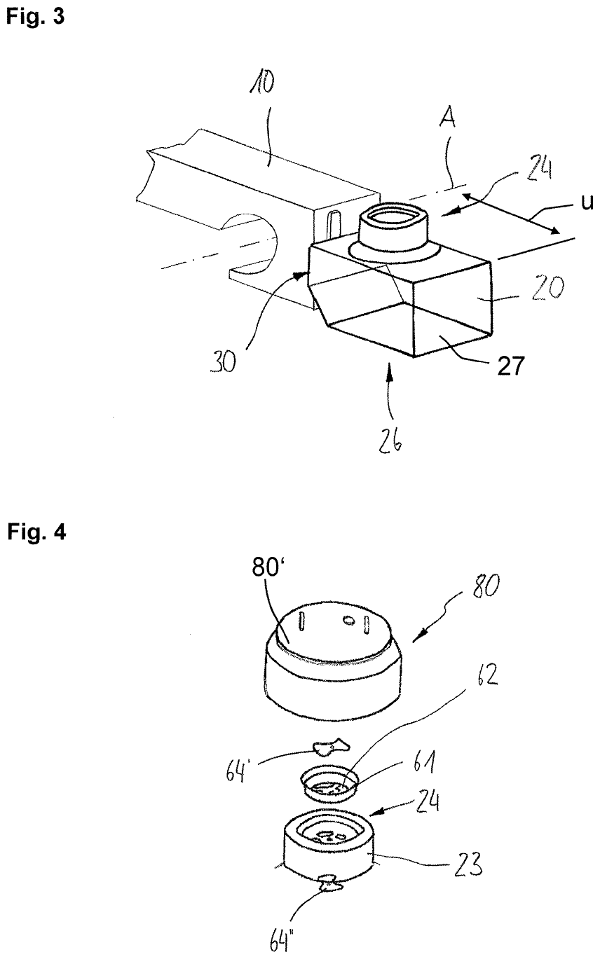

FIG. 3 shows a further embodiment of an arm end 20, comprising an access region 24 and a lower section 26 which lies substantially opposite it. In the embodiment which is shown here, the arm end 20 is arranged and fastened, for example welded, on a trailing arm 10 merely via a front section 30. Said figure also shows a projecting length u which is measured between a center of an axle tube (indicated by way of the axial direction A in the present case) and a rear section 27.

FIG. 4 shows one embodiment of a valve unit 60 with an upper valve flap 64″ and a lower valve flap 64″, and a clamping plate 61 which is arranged in a cylindrical section 23. The clamping plate 61 comprises a plurality of valve openings 62. The valve unit 61 configures an access region 24 or is arranged in the latter. A spring bellows 80′ of an air spring system 80 is arranged on the cylindrical section 23.

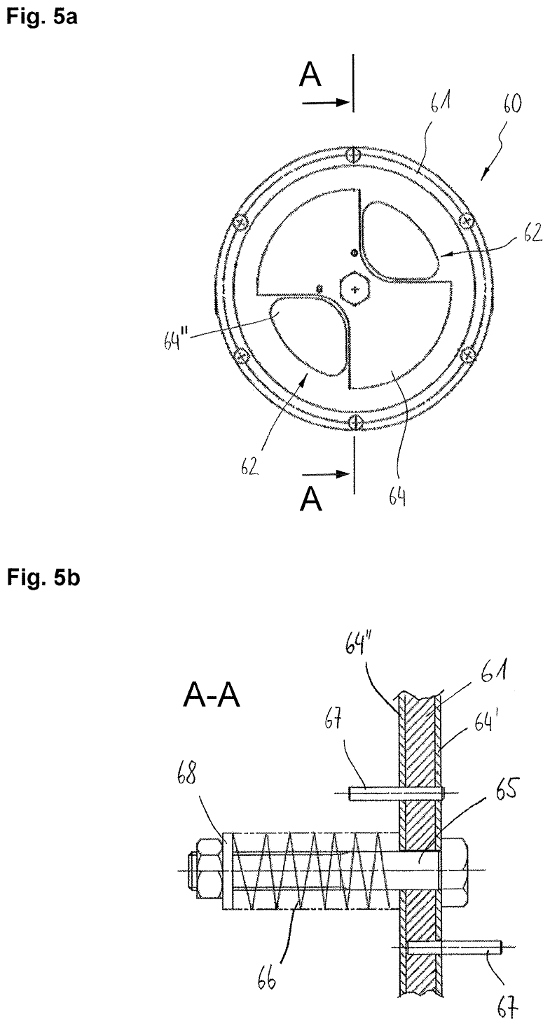

FIG. 5a shows a valve unit 60 in a plan view. A clamping plate 61 can be seen, in which an upper valve flap 64′ is inserted. A lower valve flap 64″ can be seen through the valve openings 62. On its circumference, the clamping plate 61 has a plurality of openings for fastening, for example to a main body of an arm end. A section A-A is described in FIG. 5b.

FIG. 5b shows the section A-A in FIG. 5a. The arrangement of guide pins 67 in the clamping plate 61 can be seen clearly. Said guide pins 67 prevent rotation of the valve flaps 64′, 64″. A spring element 66 in the form of a coil spring is arranged around a guide element 65. The guide element 65 is formed by way of a screw which does not have a thread in regions, as a result of which the lower valve flap 64″ can slide on the guide element 65. The spring element 66 is supported between a supporting element 68 or a washer 68 and the lower valve flap 64″. The two valve flaps 64′, 64″ are prestressed against one another as a result.

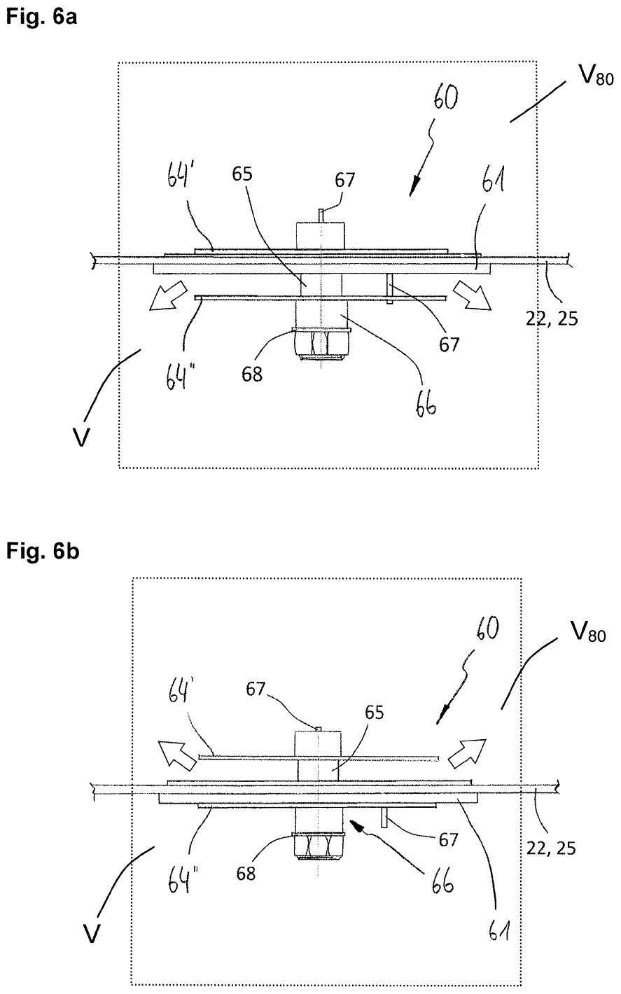

FIG. 6a shows a valve unit 60 in a side view. A clamping plate 61 is arranged in a main body 22 or in an upper section 25. The two valve flaps 64′ and 64″ are arranged on a guide element 65 and are prestressed via a prestressing or spring element 66. Guide pins 67 can also be seen. FIG. 6a shows compression, in the case of which a volume of the (air) spring bellows V₈₀ is reduced, with the result that the lower valve flap 64″ is opened counter to the force of the spring element 66 and air flows from a volume V₈₀ to a working volume V. This is indicated by way of the arrows.

FIG. 6b shows the embodiment which is known from FIG. 6a, but at a time when the volume of the spring bellows V₈₀ is increasing again. As a result of the expansion of the spring bellows, opening of the upper valve flap 64′ occurs and air flows from the working volume V back into the volume V₈₀ (see also the arrows here). This also takes place counter to the prestress of the spring element 66.

### LIST OF DESIGNATIONS

10 Trailing arm
20 Arm end
22 Main body
23 Cylindrical section
24 Access region
25 Upper section
26 Lower section
27 Rear section
28 Support face
30 Front section
60 Valve unit
61 Clamping plate
62 Valve opening(s)
64′ Upper valve flap
64″ Lower valve flap
65 Guide element
66 Spring element, compression coil spring
67 Guide pin
68 Supporting element, washer
80 Air spring system
80′ (Air) spring bellows
90 Vehicle frame/chassis
V Working volume
V₈₀ Spring bellows volume
A Axial direction
D Rotational axis
a Spacing/height
b Width
l Length
x Offset
u Projecting length

1.-13. (canceled)

14. An arm end for a trailing arm comprising:
a main body which defines a working volume for an air spring system, the main body having an access region configured to provide an access into the working volume;
wherein part of the working volume is configured substantially below the access region, the main body includes a closed hollow body, and wherein the hollow body is hydroformed.

15. The arm end as claimed in claim 14, wherein the main body is a closed hollow body.

16. The arm end as claimed in claim 14, wherein the main body includes a lower section opposite the access region, and the lower section is spaced apart from the access region by more than 5 cm.

17. The arm end as defined in claim 16, wherein the lower section is spaced apart from the access region by more than 8 cm.

18. The arm end as defined in claim 17, wherein the lower section is spaced apart from the access region by more than 10 cm.

19. The arm end as claimed in claim 14, wherein the lower section comprises a support face which is configured to arrange the arm end on a trailing arm.

20. The arm end as claimed in claim 14, wherein the main body includes a front section configured as a support or arranging face that includes a substantially horizontal outer wall configured to be arranged on and fastened to a trailing arm.

21. The arm end as claimed in claim 14, further comprising:
a valve unit that includes a clamping plate having a multiplicity of valve openings.

22. The arm end as defined in claim 21, wherein the multiplicity of valve openings includes at least four valve opening.

23. The arm end as claimed in claim 21, wherein the valve unit comprises an upper valve flap and a lower valve flap, and wherein the upper and lower flaps are arranged such that different valve openings of the multiplicity of valve openings can be opened and closed.

24. The arm end as claimed in claim 21, wherein the valve unit comprises a guide element configured such that the multiplicity of valve flaps are configured to move along the guide element.

25. The arm end as claimed claim 21, wherein the valve flaps bear against the clamping plate in a basic position such that the valve openings are closed.

26. The arm end as claimed in claim 21, wherein the valve unit comprises a spring element which prestresses the multiplicity of valve flaps.

27. The arm end as claimed in claim 21, wherein each of the multiplicity of flaps of the valve flaps includes two blades.

28. A trailing arm for commercial vehicles comprising an arm end as claimed in claim 14.

29. The trailing arm as claimed in claim 28, wherein the trailing arm and the arm end are configured in one piece.
